(19) United States
(12) Patent Application Publication
(10) Pub. No.: US 2002/0078026 A1
(43) Pub. Date: Jun. 20, 2002

(54) Method and apparatus for bulk data remover

(76) Inventor: Joseph E. Fergus, Herndon, VA (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/000,484

(22) Filed: Dec. 4, 2001

Related U.S. Application Data
(63) Continuation-in-part of application No. 09/735,896, filed on Dec. 14, 2000.

(51) Int. Cl. G06F 7/00

(52) U.S. Cl. 707/1

(57) ABSTRACT

Method and apparatus for purging information from a storage medium such as a floppy disk or a hard disk drive. A region to be purged is defined such as a storage medium or a portion of a storage medium. A purge is performed of the defined purge region by overwriting all locations in the defined purge area with a character, the complement of the character, and a random character. A number of wipe iterations may be defined where the performing is repeating until the defined number of wipe iterations is attained. The purge may also be verified by reading all locations in the purge region, and checking for inconsistent data and remaining original data by comparing all read locations with the last character written during the purge.

This application is a Continuation-In-Part of U.S. patent application Ser. No. 09/735,896 filed Dec. 14, 2000, the contents of which is expressly incorporated by reference herein.

### BACKGROUND

1. Field of the Invention

This invention relates to deletion of information in computer systems, and more specifically to the programmable removal of bulk information from computing systems.

2. Background Information

Computing systems security is becoming increasingly more important. It is not uncommon for computing systems such as computers, servers, workstations, etc. to contain sensitive information related to a corporation or entity's business, personnel, finances, or technology. In government or military computing systems, the sensitive information may related to other data, for example, strategic plans, troop movements, intelligence data, etc. A problem arises when a hostile entity gains access to the computing system and, therefore, possibly access to sensitive information. Further, computing systems may become obsolete and, therefore, it may be desired to give away, or use for other purposes the computing systems. In these situations, it may be necessary to remove all sensitive information that may reside on each computing system.

Currently, systems and methods that provide sensitive information removal generally fall into one of two categories. In the first category, the existing operating system on the computing system coexists with the facility used to remove sensitive information. In the second category, the facility that performs the removal of sensitive information contains its own operating system. The second category is problematic in that no selectivity in the type of information to be deleted is provided These type facilities are designed for a singular purpose only and are limited in that they are not configurable.

Moreover, current systems offer limited flexibility in selection of deleting or removing sensitive information from computing systems. In the case of a hostile entity, it is desired that an operator of a computing system, once detecting that a hostile entity may have gained access, may desire to immediately initiate removable of all sensitive information from the computing system. Further, it may also be desired to provide automatic initiation of removal of sensitive information without operator intervention. Current systems fail to provide these programmable options.

Therefore, there is a need for systems and methods for removal of sensitive information from computing systems that allows programmability, immediate initiation of removal, automatic initiation of removal of information, as well as bypass protection against hostile entities attempting to circumvent the sensitive information removal process.

### SUMMARY

The present invention is directed to a method for purging information from a storage medium that includes: defining a region to be purged, where the region may be a storage medium or a portion of a storage medium; and performing a purge of the defined purge region by overwriting all locations in the defined purge area with a character, the complement of the character, and a random character.

The number of wipe iterations may be defined and the purge repeated until the defined number of wipe iterations is attained. The purge may be verified by reading all locations in the purge region, and checking for inconsistent data and remaining original data by comparing all read locations with the last character written during the purge. The random characters may be generated using the date and time of a computing device, or extracting bits from the number of system clock ticks of the computing device over a period of time.

The present invention is also directed to an article that consists of a storage medium with instructions stored therein, where the instructions when executed causing a computing device to perform: receiving a definition of a region to be purged, where the region includes a storage medium or a portion of a storage medium; and performing a purge of the defined purge region by overwriting all locations in the defined purge area with a character, the complement of the character, and a random character.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a block diagram of an example computing system for removal of sensitive information according to an example embodiment of the present invention;

FIG. 2 is a flowchart of an example process for removal of sensitive information from a computing system according to an example embodiment of the present invention;

FIG. 3 is a flowchart of an example process for selecting information removal configurations and options according to an example embodiment of the present invention;

FIG. 4 is a flowchart of the remainder of the example process for selecting information removal configurations and options of FIG. 3 according to an example embodiment of the present invention;

FIG. 5 is a diagram of an example display screen menu for entering configuration information according to an example embodiment of the present invention;

FIG. 6 is a diagram of an example display screen that allows a user to enter options desired during a purge of information;

FIG. 7 is a diagram of an example display screen showing an example script executable purge file according to an example embodiment of the present invention;

FIG. 8 is a flowchart of an example process for initiation of a purge of information in a computing system according to an example embodiment of the present invention;

FIG. 9 is a flowchart of an example process for resuming a purge after a computing system has been powered off and then back on according to an example embodiment of the present invention;

FIG. 10 is a block diagram of an example system with multiple computing devices for programmable removable of sensitive information according to an example embodiment of the present invention;

FIGS. 11 and 12 are a flowchart of a user interface data remover process according to an example embodiment of the present invention; and

FIG. 13 is a flowchart of a data remover process according to an example embodiment of the present invention.

### DETAILED DESCRIPTION

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The particulars shown herein are by way of example and for purposes of illustrative discussion of the embodiments of the present invention. The description taken with the drawings make it apparent to those skilled in the art how the present invention may be embodied in practice.

Further, arrangements may be shown in block diagram form in order to avoid obscuring the invention, and also in view of the fact that specifics with respect to implementation of such block diagram arrangements is highly dependent upon the platform within which the present invention is to be implemented, i.e., specifics should be well within purview of one skilled in the art. Where specific details (e.g., circuits, flowcharts) are set forth in order to describe example embodiments of the invention, it should be apparent to one skilled in the art that the invention can be practiced without these specific details. Finally, it should be apparent that any combination of hard-wired circuitry and software instructions can be used to implement embodiments of the present invention, i.e., the present invention is not limited to any specific combination of hardware circuitry and software instructions.

Although example embodiments of the present invention may be described using an example system block diagram in an example host unit environment, practice of the invention is not limited thereto, i.e., the invention may be able to be practiced with other types of systems, and in other types of environments (e.g., servers).

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The present invention relates to systems and methods for programmable removal of sensitive information from computing systems that allows programmability of options regarding the removal of sensitive information. The present invention deletes files, directories, or the complete contents of an entire disk (hard or virtual). Systems and methods according to the present invention are flexible and programmable allowing a user to pre-select how, where, and when information is to be deleted from a computing system. A graphical user interface (GUI) on a display of the computing system may be used by a user to make the pre-selections.

Unlike the “Delete” feature in an operating system, e.g., Windows, the present invention deletes the file/directory information in the File Allocation Table (FAT) as well as overwriting the entire file in physical memory one or more times. Therefore, information retrieval after deletion (or purge) is impossible since the information no longer resides in the computing system.

In systems and methods according to the present invention, a user may generate multiple purge files, and select amongst the multiple purge files to determine which one will be used when a purge of sensitive information is initiated. Further, the user may designate one or more hot keys whereby once depressed, the removal of sensitive information is automatically initiated. Moreover, in systems and methods according to the present invention, the system may be set up to detect a programmable number of unsuccessful logon attempts to a computing system which will thereby initiate automatically the purge of sensitive information from the computing system.

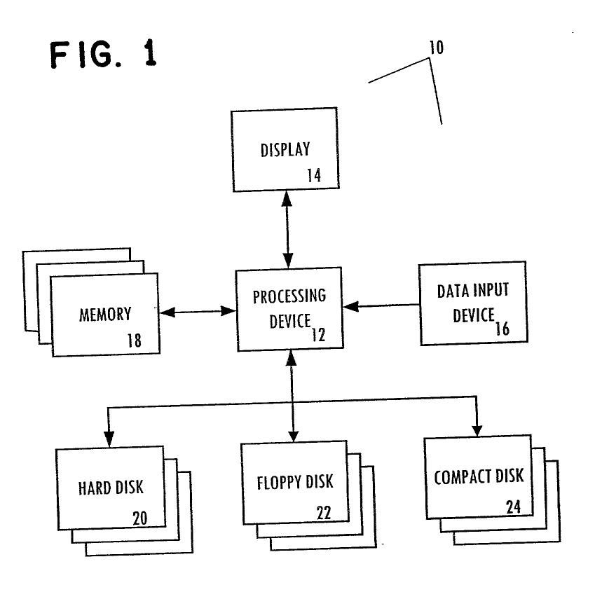

FIG. 1 shows a block diagram of an example computing system for removal of sensitive information according to an example embodiment of the present invention. The computing system 10 includes a processing device 12 (which may be any type of processor or microprocessor), a display 14, one or more a data input devices 16 (e.g., a keyboard, mouse, etc.), one or more storage devices 18-24 that may store sensitive information. The storage devices may be one or more memories 20, hard disks 20, floppy disks 22, or compact discs 24. Data input device 16 may be used to enter options related to the removal of sensitive information. Display 14 may provide a user of computing system 10 with a graphical user interface (GUI) that allows easy selection and entering of options related to removal of sensitive information or other information. Although computing system 10 is shown with multiple memories, hard disks, floppy disks, or compact discs, any computing system that includes one or more of any of these devices are within the spirit and scope of the present invention. Further, storage devices 18-24 may not exist in a computing device and still be within the spirit and scope of the present invention if the computing system contains information otherwise stored in the computing system that is to be removed. Computing system 10 may include information that resides in any one of memory 18, hard disk 20, floppy disk 22, or compact disk 24, or any other storage device.

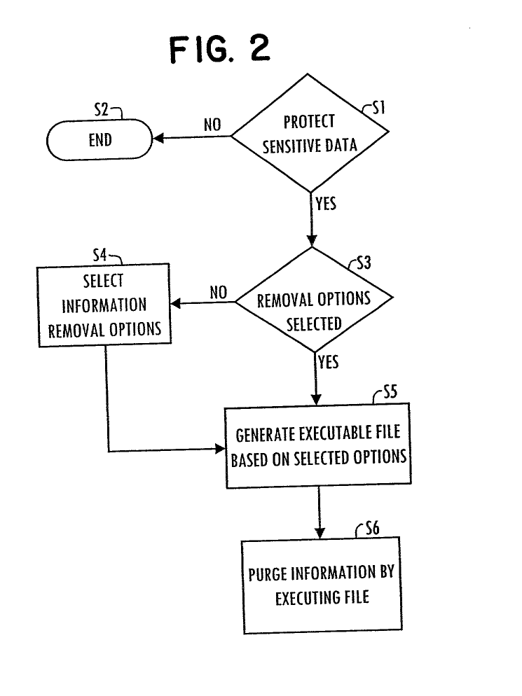

FIG. 2 shows a flowchart of an example process for removal of sensitive information from a computing system according to an example embodiment of the present invention. Initially, it is determined if there is sensitive data or information (or other information) on the computing device or system that it is desired to protect S1. If there is no sensitive information that may require protection, the process terminates S2. If there is sensitive information that it is desired to protect, it is then determined if information removal options have been selected S3. If removal options have not been selected, the user may then select information removal options S4. These options define what information is to be removed (i.e deleted, purged) upon initiation of a purge. Further, as will be shown following, these options define other factors that are used during the purge of information. After the options have been entered, an executable file is generated based on the selected information removal options S5. The executable file contains instructions and/or commands that perform the removal of the desired information. The executable file may be in the form of any computer language that may perform removal of information from a computing system, however, preferably this language is a script language that is easily executable by the computing system. The executable file is then executed and the information purged from the computing system S6. The information is purged by deleting the file/directory information in the File Allocation Table (FAT) as well as overwriting the entire file in physical memory one or more times. The number of overwrites is programmable by the user. One or more entire disk drives may be purged by performing a low level sector-by-sector purge of all information on the selected disk(s).

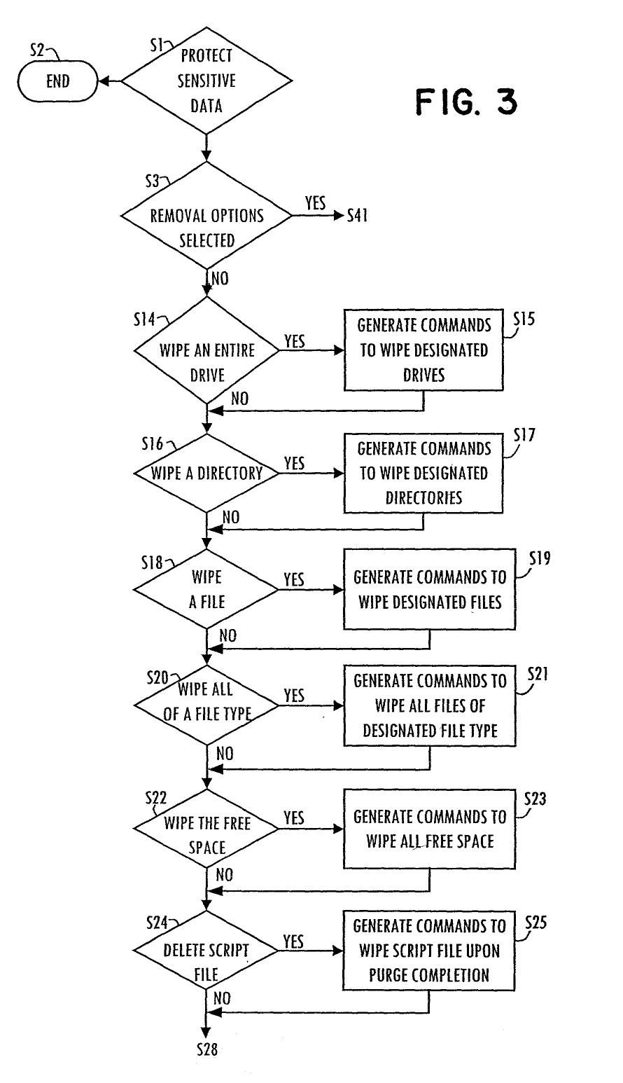

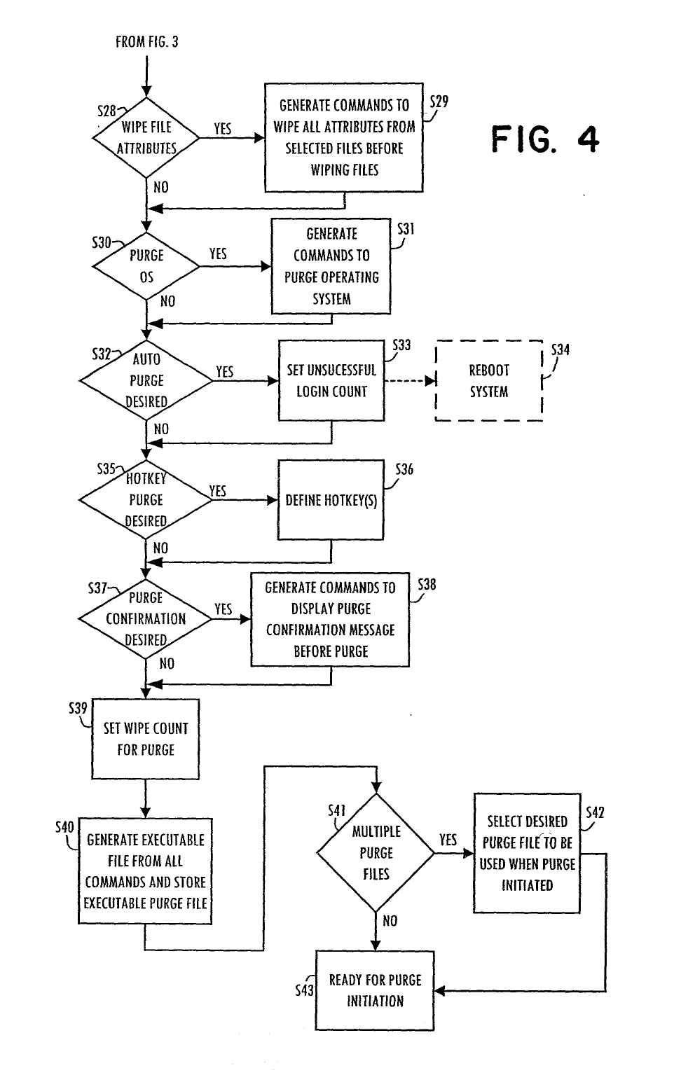

FIG. 3 is a flowchart of an example process for selecting information removal configurations and options according to an example embodiment of the present invention. As noted previously, it is first determined whether there is information (sensitive or otherwise) that it is desired to protect S1, and if not the process ends S2. It is then determined whether removal options have been selected S3. If removal options have been selected, the process continues on FIG. 4 at S41. If removal options have not been selected, then the process proceeds to provide the user with selectable options that will be used to create the executable file and, therefore, purge sensitive information on the computing system upon execution of the executable file. It is preferable that the executable file be a script file, therefore, the terms “executable file”, “purge file”, and “purge script file” may be used interchangeably to illustrate the present invention. However, the invention is not limited to the use of a script file, and any executable file that allows instructions and/or commands that perform deletion of information from a computing system are within the spirit and scope of the present invention. Further, the terms “wipe”, “delete”, and “purge” all relate to removal of information from a storage device and may be used interchangeably to describe and illustrate the present invention.

A user determines if it is desired to wipe an entire disk drive S14. This relates to wiping all information from a particular drive, for example a “C” hard drive, “A” floppy drive, “D” compact disc (CD) drive, etc. on a computing system. When this option is selected, a low level purge of information from the drive may be performed that not only wipes sensitive information, but performs a wipe of all information on the selected drive on a sector by sector basis. The purge occurs on the selected one or more drives from the first sector through the last sector.

If the user selects to wipe an entire drive, commands may be generated to wipe the designated drives S15. The user may also select to wipe one or more specific directories in the computing system S16. If the user selects to wipe one or more particular directories, commands may be generated to wipe the designated directories S17. The user may select to wipe just one or more particular files S18. If the user desires to wipe a particular file, commands may be generated to wipe the designated files S19. The user may also select to wipe all files of a particular file type S20. For example, the user may desire that all file types of, for example, “.doc”, “.exe”, “.wp”, “.bin”, “.com,”, etc. be deleted upon the initiation of a purge. If this option is selected by the user, commands may be generated to wipe all files of the designated file type S21. The user may enter one or more different file types under this option. All file types in the computing system regardless of where stored, may be wiped if this option is selected.

It may be desired and selected to wipe all free space in storage devices of the computing system S22. This option may be used to purge all unused or free space in the computing system, or on a specific drive. Free space may occur after an end of file (EOF) marker and before the next sector or cluster physically begins on a drive. Selection of this option causes the purge of all the free space on the drive to ensure no left over or residual information remains on the drive. If the user selects this option, commands may be generated to wipe all free space on the one or more selected drives 323. The user may also select to have the executable file or script file deleted after completion of the purge S24. This option deletes the contents of the script file once the purge is complete The default value may be set to off. If this option is selected, commands may be generated to wipe the executable or script file upon purge completion S25.

FIG. 4 shows a flowchart of the remainder of the example process for selecting information removal configurations and options of FIG. 3 according to an example embodiment of the present invention. The user may select an option that causes the attributes of selected files to be purged to be wiped before the purge of the selected files S28. There are certain file attributes or parameters that may be associated with files in computing systems. These attributes may include, for example, read-only, write-only, archive, hidden, etc. Some attributes may hinder or prevent a particular file from being deleted or removed, for example, a read-only attribute cannot be written to or deleted until that attribute is first removed. Therefore, a wipe or clear attributes option according to the present invention allows a user to clear all attributes of a given file before that file is wiped from the system. If the wipe attribute option is turned off, it is possible that files protected by read-only or hidden attributes may not be wiped when the purge of information is initiated. If the user selects the option to wipe file attributes, commands may be generated to wipe all attributes from selected files before purging the files S29. The user may also select to purge the operating system S30. This option may disable the operating system on the next system boot by deleting operation system files before they have time to boot up. If this option is selected, commands may be generated to purge the operating system S31.

An auto purge option may also be selected S32. When this option is active, a system initiated purge may automatically occur when a pre-specified number of unsuccessful logon attempts is made to the computing system. When this option is selected, the user must also enter a number of unsuccessful logon attempts detected before the automatic purge is initiated S33. Depending on the computing system, the computing system may need to be rebooted to ensure activation of this option S34.

The user may also select an option which allows hotkey initiation of the purge of information S35. If a user selects this option, the user must define one or more hotkeys that once pressed initiate a purge S36. The hotkey may be composed of a single key, or two or more keys. If multiple keys are selected, one key may be a hotkey modifier, for example, Shift, WIN, Alt, Ctrl, etc., and any other key on the keyboard, for example, A-Z, 0-9, F1-F12, +, End, etc. If hotkey purge is selected, once the hotkey sequence occurs, a purge of the information is initiated. The user may also desire that a confirmation message be displayed asking the initiator of a purge whether they are sure they want to purge information S37. If this option is selected, when a purge operation is initiated (except for an automatic purge), a menu box may be displayed prompting the user to select yes or no (or OK, Continue, Cancel, etc.) to confirm the purge of information before the purge S38.

In systems and methods for programmable removal of sensitive information from a computing system according to the present invention, a user may set a wipe count to be used for the purge of the information. The wipe count may be used to set the number of overwrites of the storage locations when a purge is performed. Each pass (i.e., wipe) may write a different pattern to the storage locations from the previous wipe. For example, one pass may write the binary values of all zeros (e.g., “00000000” etc.), whereas the following pass writes the compliment of this, i.e., all ones (e.g., “11111111”). There may be a default number of overwrites set. For example, a default number of three overwrites may exist if no other number is set. However, the user may enter anywhere from zero to a set maximum in the wipe count box to denote the number of overwrites used during a purge of the information.

Once all options have been selected, an executable file may be generated from all the commands representing the selected configurations and options, and stored as an executable purge file S40. As noted previously, this executable file may use commands or be written in a language from any programming language, however, it is preferable that the executable file be a script file for easy execution by the computing device.

Systems and methods according to the present invention allow multiple script files to be generated and stored. For example, one script file may be generated whereby all information on a particular selected drive is wiped upon initiation of a purge. Another script file may have been generated whereby only files of a particular file type are wiped upon the initiation of a purge. Thus, multiple purge files may exist S41. If multiple purge files do exist, the user may be required to select a desire purge file to be used when a purge is initiated S42. Upon the selection of a purge file, the computing system is ready for any purge initiation S43. Therefore, depending on the options or configurations chosen by a user, an executable purge file may be created that when executed performs the purge functions desired. Once created, executable purge files may be viewed by the user using a wordprocessor and manually edited if desired.

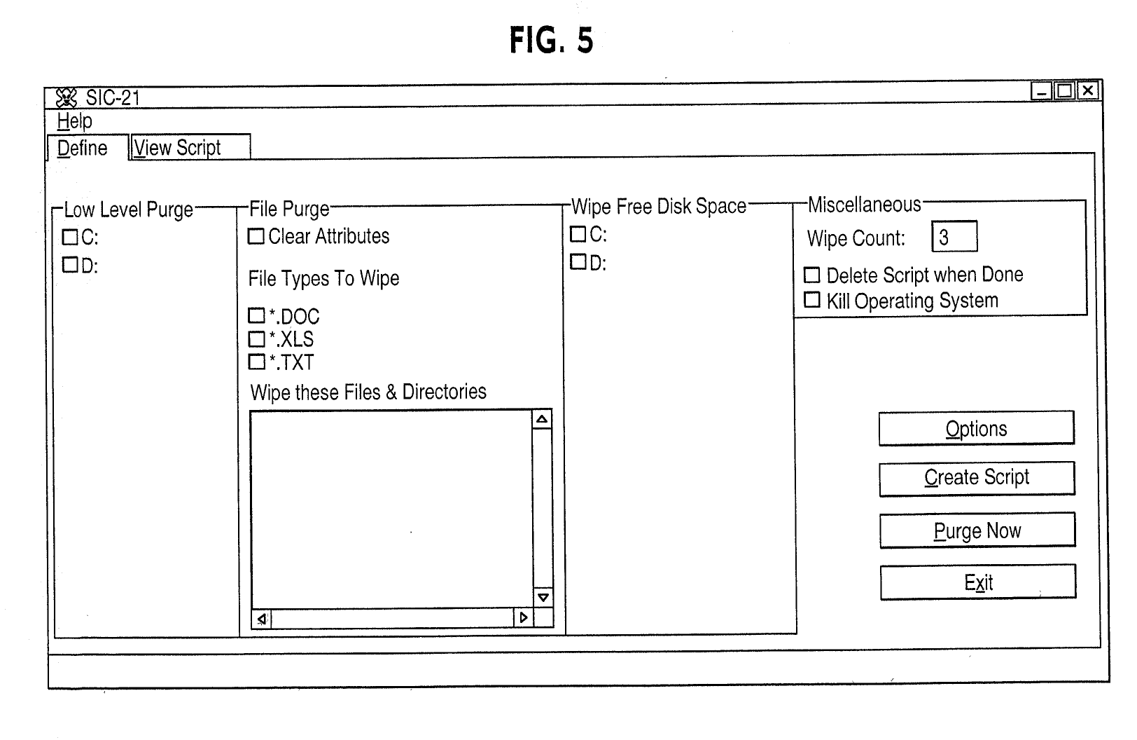

FIG. 5 shows a diagram of an example display screen menu for entering configuration information according to an example embodiment of the present invention. As shown in FIG. 5, and noted previously, the user may select a low level purge of one or more disk drives, select to wipe the attributes from a particular file, select to wipe all files of a particular file type, manually enter file types and/or associated directories, select to wipe the free disk space of a particular drive, select a wipe count, select deletion of the script file or executable file when purge is completed, select to kill or wipe the operating system during purge, etc.

After selecting the configuration, the user may then select “Create Script” which causes the executable file to be created that will be executed to perform the purge of information. If a purge file already exists or has been selected, the user may select the “Purge Now” option that initiates execution of the purge of the information. Further, the system may include an online help capability designed to provide quick answers to the most common concerns of a user. The “Options” button, when selected, presents another menu screen for selection of various options by a user that may also be used in creation of the executable purge file.

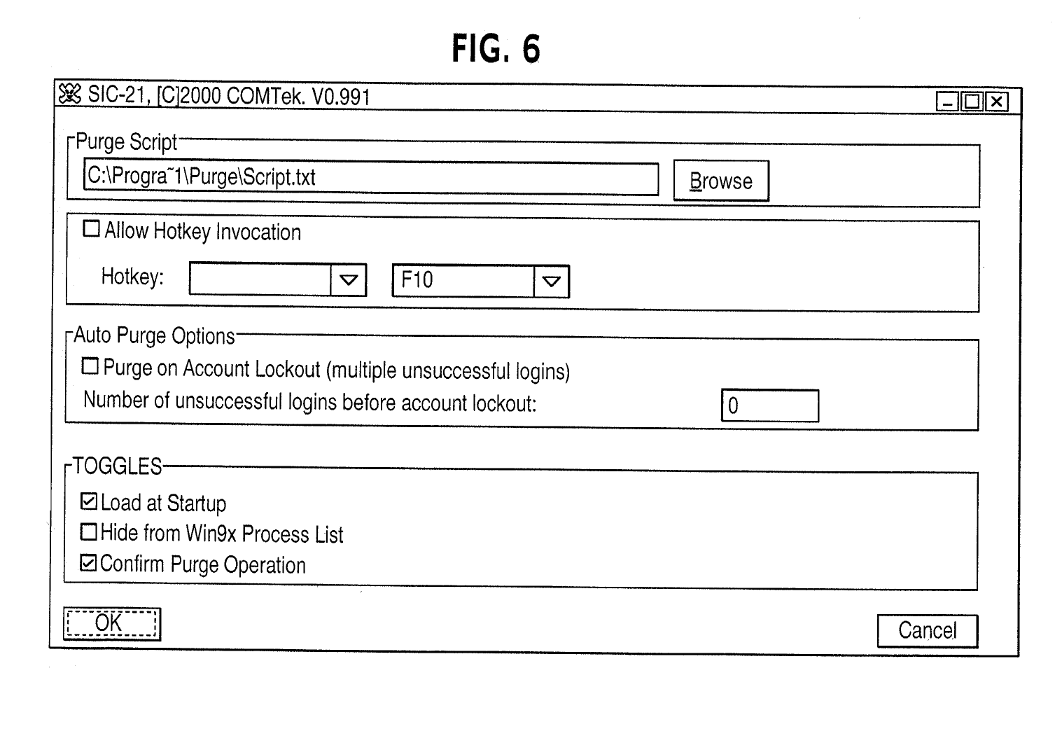

FIG. 6 shows a diagram of an example display screen that allows a user to enter options desired during a purge of information. As shown in FIG. 6, the menu may provide the name of the executable purge file which allows the user to browse or edit the file. Further, input boxes may be displayed allowing the user to select one or more hotkeys, along with a box to activate the hot key invocation. The user may also activate a box which enables an automatic purge of information to occur upon a particular number of unsuccessful logins. The screen also provides an input box for the user to enter the number of unsuccessful logins desired to be detected before automatic purge begins.

One or more options may also be selected under toggles, for example, load on start up which when selected causes an icon for the purge facility to appear in the system tray on the end opposite the start button on the task bar in a Windows Desktop display screen. A default may be set whereby this option is on. If a hide from Win9x box is enabled, the purge program may not appear in the Ctrl-Alt-Delete process list in Windows 9x. A preferred default value of off may be desired for this option. Moreover, as noted previously, the user may be given an option to request confirmation of a purge operation. If this option is selected, whenever a purge is initiated manually, a purge verification window may appear and the user must click “ok” (or other authorizing command) before the purge is initiated. A default value of on may be desirable for this function to prevent inadvertent purge of information.

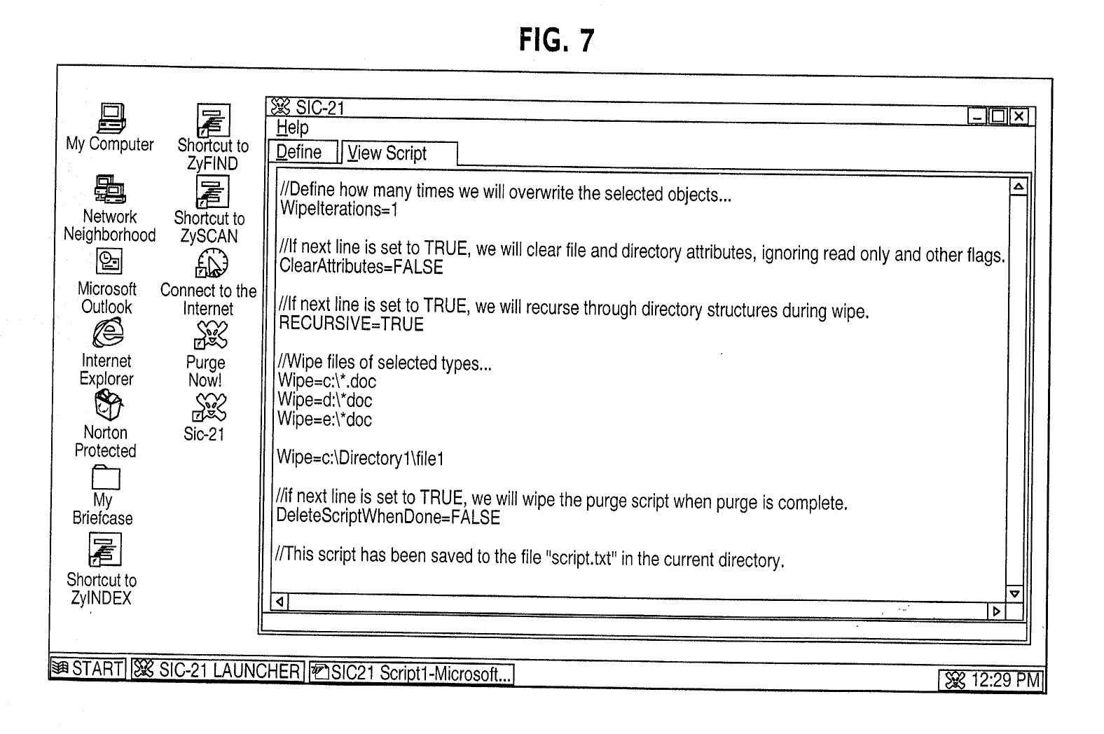

FIG. 7 shows a diagram of an example display screen showing an example script executable purge file according to an example embodiment of the present invention. In the purge file, “//” denote comments in the file describing the function of the command on the line below the comment. As can be seen from looking at the comments, the user has selected wipe iterations equal to one which will cause only one overwrite of selected information. Further, the clear attributes option has been set equal to false, therefore, attributes associated with files and directories will not be wiped. Next, the user has selected to wipe all files of file type “.doc” from drives “C”, “D” and “E”. The user has also entered or selected “file 1” on the “c” drive in directory “Directory 1” for deletion. The user has further selected not to wipe the purge script file once the purge of information is completed. This is an example script file, however, a script file may include much more information based on configurations and options selected by a user than the examples shown in FIG. 7. Further, a script file may consist of only one or two commands and still be within the spirit and scope of the present invention. In any event, the script file defines the sequence of commands that will be executed upon initiation of a purge as well as the information to be purged.

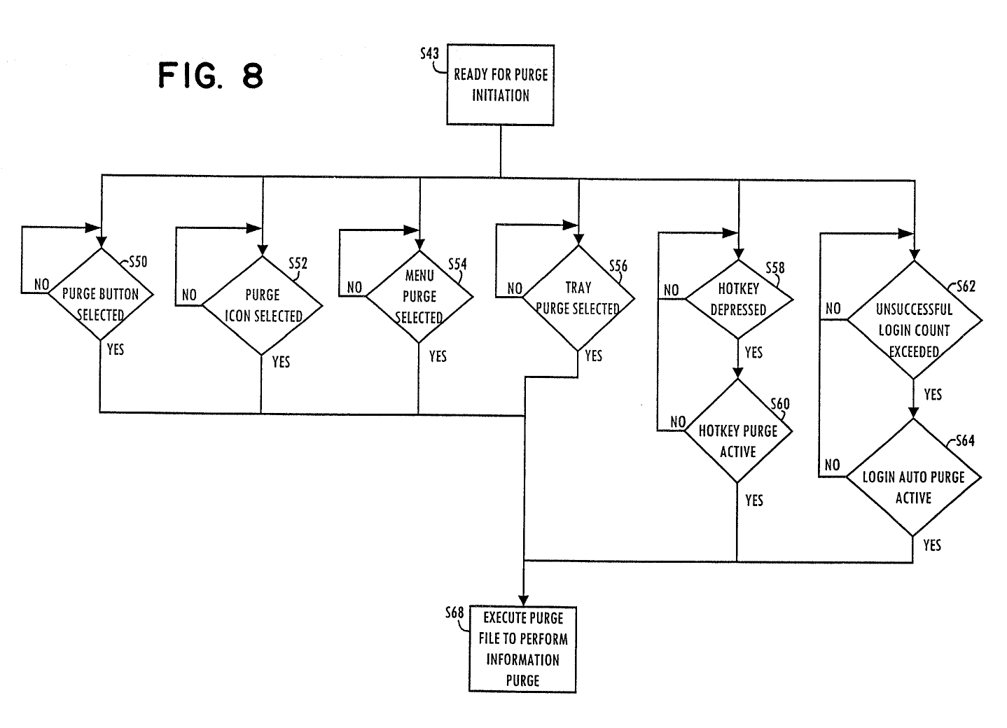

FIG. 8 shows a flowchart of an example process for initiation of a purge of information in a computing system according to an example embodiment of the present invention. Once the user has selected all configuration and purge options, and an executable file has been generated and stored, the system is ready for purge initiation S43. The computing system has a defined executable purge file and awaits for any one of many possible events to occur that may initiate a purge of information. The “Purge Now” button in the screen shown in FIG. 5 may be selected S50. If the purge button is selected, the purge file is executed to perform the information purge S68. Further, a purge icon may be selected S52. The purge icon may exist on a main screen or desktop screen of a graphical user interface of the computing system. If selected, this will also initiate the purge of information S68. Moreover, a purge may be initiated by going to a menu and selecting a purge from the menu S54. The purge command may exist under a drop down menu such as file, edit, options, etc. Once selected, information is purged from the computing system by executing the purge file S68.

As noted previously, a purge icon may also be resident in the tray at the bottom of a Window's display S56. Upon selection of this icon in the tray, the purge file may be executed and a purge of information performed S68. The computing system may note that certain hotkeys have been depressed S58. A check may be performed to determine if a hotkey purge is active and if not, nothing occurs 360. If a hotkey purge has been set active, then a purge of information will occur S68. The purge facility on the computing system may monitor the hotkey(s) if the hotkey purge is active, and immediately initiate the purge of information upon detection of the hotkey(s) being selected.

Moreover, the computing system may detect that multiple unsuccessful logins have been attempted on the computing system S62. If the number of unsuccessful logins have been exceeded, the system may determine if login automatic purge is active S64 and if not, nothing may occur. If automatic purge is active, then a purge is automatically performed which purges the selected information on the computing system S68. Therefore, in system and methods for a programmable removable of sensitive information from a computing system according to the present invention, a purge of sensitive information or other information may be initiated by any one of multiple methods.

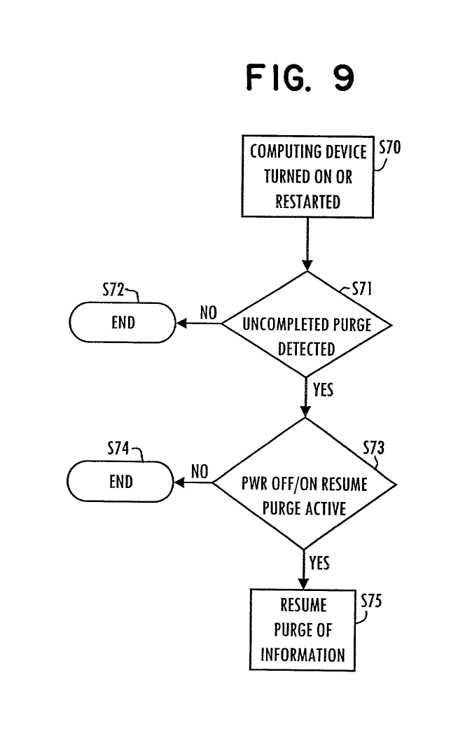

FIG. 9 shows a flowchart of an example process for resuming a purge after a computing system has been powered off and then back on according to an example embodiment of the present invention. A hostile entity may attempt to bypass a purge operation by turning the computing device off and then turning the computing device back on, or restarting the computing device S70. The purge facility on the computing system may then determine if a uncompleted purge is still pending S71, and if not, no further action is taken S72. If the system detects that a purge had been in progress, but was not completed, the system may then determine if the user has selected to resume a purge after a power off and back on or restart S73. This may be an option that is selected in a configuration or options menu. If a resume purge has not been set active, the process ends S74. If the resume purge has been set active, the system may then resume purge of the information S75. Therefore, a hostile entity is not allowed to bypass or circumvent a purge operation by either turning the computing device off and then back on, or restarting the computing device.

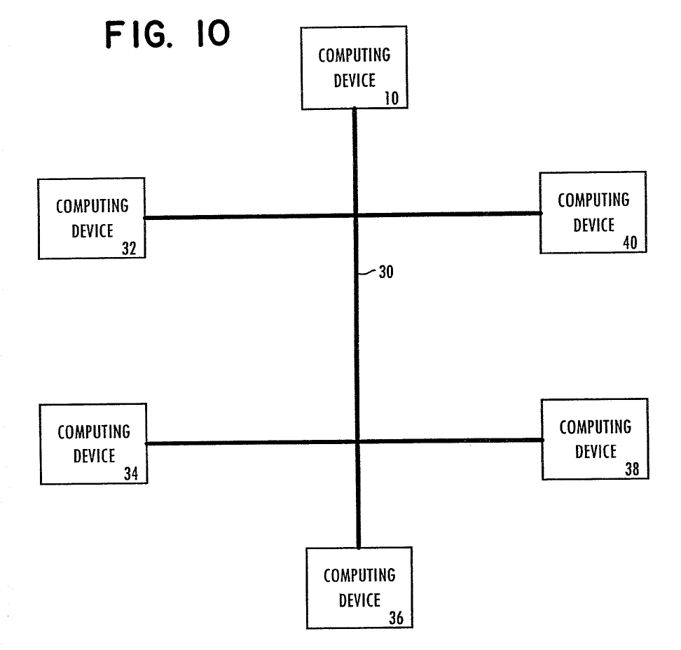

FIG. 10 shows a block diagram of an example system with multiple computing devices for programmable removable of sensitive information according to an example embodiment of the present invention. As shown in FIG. 10, two or more computing devices 10 may be configured in a network 30. Each computing device, 10, and 32-40, may communicate with each other over network 30. Therefore, one computing device in the network 30, e.g., computing device 10, may initiate the purge of information from one or more other computing devices, e.g., 32-40. This is advantageous in that a purge of sensitive information may be initiated remotely from the location of the sensitive information. Network 30 may be any of many types of networks, e.g., a local area network (LAN), wide area network (WAN), or a wireless local area network (WLAN). Further, one or more of computing devices 10 and 32-40 may be a portable computing device such as a laptop computer, mobile control or processing device, personal digital assistant (PDA), etc. This provides increased security in that should a hostile entity attempt a number of unsuccessful logins at, for example, computing device 36, computing device 36 may report this to another computing device, for example, computing device 32, whereby computing device 32 may initiate and monitor the purge of sensitive information that resides at computing device 36. This is advantageous in that a hostile entity attempting to turn off or restart computing device 36 can not defeat the purge of information since is being monitored and/or initiated by a remote computing device 32.

Moreover, the present invention relates to a data remover that performs purges of an entire storage medium, e.g., hard drive, or a subset of the storage medium, e.g., partitions or sectors. The present invention performs a multi-iteration wipe and verify process where all data is wiped from a target region or purge region in a manner that leaves the wiped data irretrievable by current and anticipated technology.

Data in the purge region is overwritten by a wipe character. The wipe character may change on each iteration of the purge. For every three iterations of the wipe, the wipe character a specific character on the first iteration, to the compliment of the character on the second iteration, and finally to a random generated character on the third iteration. For example, the wipe character may be a byte of 0 on the first iteration, the compliment of 0, i.e., 1, on the second iteration, and finally to the random generated byte on the third iteration. Moreover, a user may choose to verify the purge of data or information. The verification of the purge may be performed after the last iteration.

In an example embodiment of the present invention of the storage medium being a hard disk drive of a computer, data may be written in blocks of 127 sectors, with the exception of the last block which may be less than 127 sectors if the total number of sectors on the target region is not a multiple of 127. Personal computer Basic Input/Output System (BIOS) interrupt 0x13 may be used to perform all of the writing of data. Where available, interrupt 0x13 extensions with logical addressing may be used instead of the original interrupt 0x13 specification. These extensions allow for referencing of disks larger than what the cylinder head addressing (CHS) scheme of the original interrupt 13h specification may allow for.

The random wipe character used for every third iteration may be obtained from the system clock by polling interrupt 0x1A and extracting the lowest 8 bits of the number of system clock ticks since midnight. For example, there may be 18.2 clock ticks per second. Similarly, the Julian date composed of the day and time may be used to generate the random wipe character. These methods provide for reasonably random wipe characters whose unpredictability is contingent on the lack of knowledge of what time was indicated by the system clock (down to the number of clock ticks) when it was polled.

A verification process may be performed by reading the target region and checking for inconsistent or remaining data in the target region. After a successful purge, every byte in the target region equals every other byte, which is the last wipe character. Therefore, in the example embodiment of a hard drive in a personal computer, each 127 sector blocks may be checked to make sure that all bytes are equal and correspond to the byte used to fill the previous blocks. If a read error occurs or the data is inconsistent, the verification process fails and an error message may be generated that reports that the target purge region may not be fully sanitized.

As mentioned previously, in apparatus and methods according to the present invention, an entire storage medium or any partition or portion of the storage medium may be selected to be purged. The storage medium may include any medium that stores data, for example, a floppy disk, a hard disk drive, a zip drive, etc. Further, a portion of the storage medium may be a partition such as a virtual disk, a sector, etc.

Moreover, the number of iterations or wipes performed on the data in the storage medium may be variable. For example, it may be desired to perform three wipe iterations on the data, five wipe iterations on the data, or nine wipe iterations on the data. To illustrate, if three iterations or wipes are selected, a wipe character may be used for the first iteration, the compliment of the wipe character used for the second iteration, and a random character generated and used for the third iteration to overwrite the data on the storage medium. If for example, five iterations are selected, then the wipe character may be used for the first iteration, the compliment of the wipe character used for the second wipe of the data, a random character used for the third iteration, the wipe character used for the fourth iteration, and the compliment of the wipe character used for the fifth iteration wipe of the data. If nine iterations are selected, then the wipe character may be used for the first iteration, the compliment of the wipe character used for the second iteration, a random character used for the third iteration, and this pattern repeated until all iterations or wipes have been completed. For iterations that use a random character, a different random character may be used for each time since the number of system clock ticks is different for each wipe iteration.

The present invention may be embodied on a floppy disk, compact disk, or other medium that may be inserted into a computing system that has data that is desired to be purged. Therefore, no operating system or other software is required to be resident on the computing system to support removal of data according to this data remover embodiment of present invention. The present invention may be highly advantageous in wiping storage mediums of computing systems of computers of corporations, organizations or other entities that desire to now get rid of the computing systems and ensure that no sensitive or other data is left remaining on the storage mediums of the computing systems. Once a purge of the information is performed and a positive verification (if desired) is achieved, the floppy disk, compact disk, etc. may simply be removed from the computing system and used in another computing system that has information to be purged.

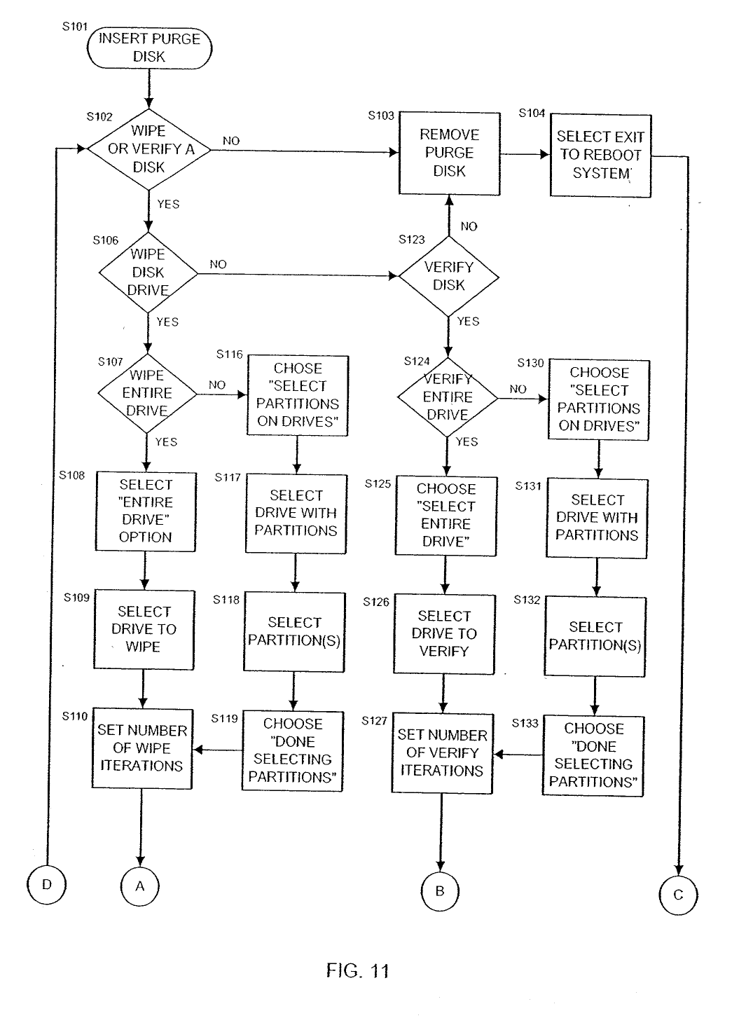

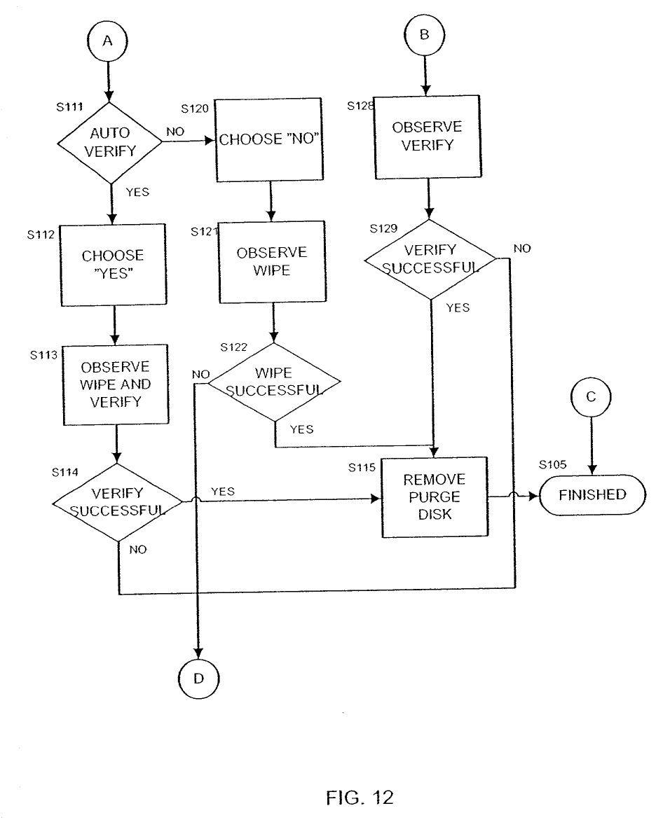

FIGS. 11 and 12 show a flowchart of a user interface data remover process according to an example embodiment of the present invention. In this embodiment, the storage medium to be wiped is a disk drive in a computing system. A disk or CD with the purge application is inserted into the computing system S101. The user determines if it is desired to wipe a disk drive or verify a disk drive S102. If none of the above, the user may then remove the disk S103, reboot the system S104, and the process terminates S105. If the user does desire to wipe or verify a disk, the user determines whether it is desired to wipe a disk drive S106, and if not whether it is desired to verify a disk drive S123.

If it desired to wipe a disk, it is determined whether the entire disk is to be wiped S107. If the entire disk is to be wiped, the user may select an “entire drive” option on the user interface, S108, select the drive to wipe S109, and set the number of desired wipe iterations S110. If it is not desired to wipe an entire disk drive, the user may choose “select partitions on drives” S116, select the particular disk drive with the partitions S117, and the particular partitions to be wiped S118. The user then may choose a “done selecting partitions” option S119, and then may set the number of wipe iterations S110.

The user then may make a decision as to whether automatic verification is desired S111, and if so chooses “yes” S112 and if not chooses “no” S120. If the user chooses “no”, the user may observe the wipe S121, determine if the wipe is successful S122, and then if successful, remove the disk with the purge application S115 and the process concludes S105. If the wipe is not successful, the user may decide to perform the wipe again and begin the process all over from step S102. If automatic verification is desired, the user chooses “yes” S112, may observe the wipe and verify S113, and determines whether the verify was successful S114. If the verify was successful, the user may then remove the purge application disk S115 and the process concludes S105 the verify was not successful, the user may then decide to initiate the process again by returning to step S102.

If the user does not choose to wipe a disk drive S106, but does choose to verify a disk drive S123, the user decides whether it is desired to verify the entire disk drive S124. If the entire disk drive is desired to be verified, the user may choose “select entire drive” S125, select a drive to verify S126, and set a number of verify iterations desired S127. If the user does not desire to verify an entire drive, the user may choose “select partitions on drive” S130, select the disk drive with the partitions S131, select the partitions to be verified S132, and choose “done selecting partitions” S133. The user may then set the number of verify iterations desired S127.

The user may observe the verify S128 and determine if the verify was successful S129. If the verify was successful, the purge application disk may be removed from the computing system S115 and the process terminates S105. If the verify was not successful, the user may desire to perform the process again by returning to step S102.

Although the process shown in FIGS. 11 and 12 include particular options and selections by the user, any user interface that provides these or similar selections are within the spirit and scope of the present invention. For example, the user interface may instead provide icons or other graphic images for selection by the user in selecting various options. Further, options may be selected in a pull down menu or command line and still be within the spirit and scope of the present invention. Moreover, other options not shown may be included that relate to the purging or verifying of data on a storage medium or portion of a storage medium and still be within the spirit and scope of the present invention. In addition, the present invention may be implemented with fewer options than shown in the example embodiment of FIGS. 11 and 12.

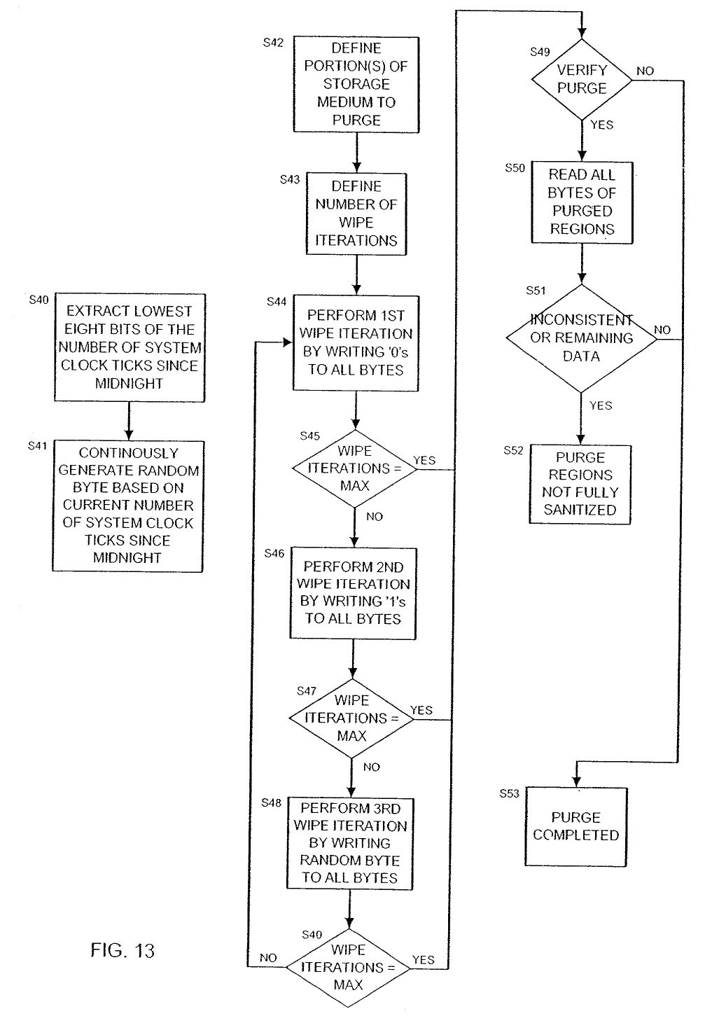

FIG. 13 shows a flowchart of a data remover process according to an example embodiment of the present invention. A continual process may occur whereby the lowest 8 bits of the number of system clock ticks since midnight may be constantly extracted S140 and a random character or byte continuously generated based on the current number of system clock ticks since midnight S141. Initially, as noted previously, a storage medium or portion of a storage medium is defined to be purged S142. The number of wipe iterations may also be set S143.

A first wipe iteration may be performed by writing a first character, for example ‘0’, to all bytes in the selected purge region S144. A determination is made as to whether the number of wipe iterations is equal to the maximum S145, and if so, it is determined whether a purge verification is desired S149. If the number of the wipe iterations has not been reached, a second wipe iteration is performed by writing the compliment of the first iteration character, for example ‘1’, to all bytes in the purge region S146. Again it is determined if the number of wipe iterations has reached its max S147, and if so, a decision may be made as to whether verification of the purge is desired S149. If the number of wipe iterations has not reached a max, a third wipe iteration is performed using a random character or byte that is written to all bytes or locations in the purge region S148. Again, a determination is made as to whether the number of wipe iterations have reached the set maximum, and if so, a decision may be made as to whether verification of the purge is desired S149. If the number of wipe iterations has not reached the maximum number set, the first wipe iteration may be performed again S144 and the process repeated until the number of desired wipe iterations has occurred.

If verification of the purge is desired S149, all bytes or locations of the purged regions are read S150. A determination is made as to whether inconsistent or remaining data resides in the bytes and locations of the purged regions S151, and if not, the purge has completed S153. If there is inconsistent or remaining data in the bytes and locations of the purge region, a message or alert may be generated that signifies that the purge regions are not fully sanitized S152. If verification of the purge is not desired S149, the purge has completed S153.

The present invention is advantageous in that with multiple iterations of wipes, and random characters being used as a part of the iteration, storage mediums or portions thereof may be sanitized in a manner that guarantees irretrievability of the previous data.

It is noted that the foregoing examples have been provided merely for the purpose of explanation and are in no way to be construed as limiting of the present invention. While the present invention has been described with reference to a preferred embodiment, it is understood that the words which have been used herein are words of description and illustration, rather than words of limitation. Changes may be made within the purview of the appended claims, as presently stated and as amended, without departing from the scope and spirit of the present invention in its aspects. Although the present invention has been described herein with reference to particular methods, materials, and embodiments, the present invention is not intended to be limited to the particulars disclosed herein, rather, the present invention extends to all functionally equivalent structures, methods and uses, such as are within the scope of the appended claims.

What is claimed is:

1. A method for purging information from a storage medium comprising:
defining a region to be purged, the region comprising one of a storage medium and a portion of a storage medium; and
performing a purge of the defined purge region by overwriting all locations in the defined purge area with a character, the complement of the character, and a random character.

2. The method according to claim 1, further comprising defining a number of wipe iterations, the performing repeating until the defined number of wipe iterations is attained.

3. The method according to claim 1, wherein the storage medium comprises one of a floppy disk and a hard disk drive.

4. The method according to claim 1, wherein the portion of a storage medium comprises one of at least one partition of the storage medium and at least one sector of the storage medium.

5. The method according to claim 1, wherein the character comprises one of a ‘1’ and a ‘0’.

6. The method according to claim 1, further comprising generating the random character by extracting bits from the number of system clock ticks over a period of time.

7. The method according to claim 1, further comprising generating the random character using the date and time.

8. The method according to claim 1, further comprising verifying the purge.

9. The method according to claim 8, wherein the verifying comprises:
reading all locations in the purge region; and
checking for inconsistent data and remaining original data by comparing all read locations with the last character written during the purge.

10. The method according to claim 8, further comprising generating a message that the purge region is not fully sanitized if the purge does not verify.

11. An article comprising a storage medium with instructions stored therein, the instructions when executed causing a computing device to perform:
receiving a definition of a region to be purged, the region comprising one of a storage medium and a portion of a storage medium; and
performing a purge of the defined purge region by overwriting all locations in the defined purge area with a character, the complement of the character, and a random character.

12. The apparatus according to claim 11, further comprising receiving a number of wipe iterations, the performing repeating until the defined number of wipe iterations is attained.

13. The apparatus according to claim 11, wherein the character comprises one of a ‘1’ and a ‘0’.

14. The apparatus according to claim 11, further comprising generating the random character by extracting bits from the number of system clock ticks over a period of time.

15. The apparatus according to claim 13, further comprising generating the random character using the date and time.

16. The apparatus according to claim 11, further comprising verifying the purge.

17. The apparatus according to claim 16, wherein the verifying comprises:
reading all locations in the purge region; and
checking for inconsistent data and remaining original data by comparing all read locations with the last character written during the purge.

18. A method for removal of information from a computing system comprising:
selecting at least one information removal option;
generating an executable file based on the selection; and
purging information from at least one computing system by execution of the executable file.

19. The method according to claim 18, wherein the executable file comprises a script file.

20. The method according to claim 18, further comprising initiating the purge remotely from the computing system.
